(19) United States
(12) Patent Application Publication
(10) Pub. No.: US 2019/0112849 A1
(43) Pub. Date: Apr. 18, 2019

(54) POWER-OPERATED VARIABLE FORCE DOOR CHECK MECHANISM FOR A VEHICULAR CLOSURE SYSTEM

(71) Applicant: MAGNA CLOSURES INC., Newmarket (CA)

(72) Inventor: Francesco CUMBO, Pisa (IT)

(21) Appl. No.: 16/159,782

(22) Filed: Oct. 15, 2018

Related U.S. Application Data
(60) Provisional application No. 62/572,745, filed on Oct. 16, 2017.

(51) Int. Cl. E05C 17/00; E05F 15/611; E05F 15/73

(52) U.S. Cl. CPC E05C 17/003; E05Y 2900/531; E05F 15/73; E05F 15/611

(57) ABSTRACT

A power-operated variable force door check mechanism for a vehicle closure panel and system therewith, and method of controlling movement of a closure panel of a vehicle is provided. The mechanism includes a continuously variable force application member configured to selectively and continuously, as needed, vary the resistance applied to an elongate check arm of the vehicle closure panel while the vehicle closure panel is being pivoted between opened and closed positions.

### CROSS-REFERENCE TO RELATED APPLICATION

This application claims the benefit of U.S. Provisional Application Ser. No. 62/572,745, filed Oct. 16, 2017, which is incorporated herein by reference in its entirety.

### FIELD

The present disclosure relates generally to articulating door systems for motor vehicles and, more particularly, to articulating door systems having powered door check mechanisms.

### BACKGROUND

This section provides background information related to the present disclosure which is not necessarily prior art.

In a conventional manner, passenger doors of motor vehicles are pivotally mounted to the vehicle body for movement between fully opened and fully closed positions. Many such vehicle doors are designed to cooperate with a check-strap, also known as a door check, which is operative for positively locating the vehicle door relative to the vehicle body between the fully opened and fully closed positions. For example, the door check is adapted to positively locate the vehicle door relative to the vehicle body at an intermediate position between the fully opened and fully closed positions. In situations where the vehicle door is desired to be opened to a position less than the fully opened position, such as when a space laterally adjacent the vehicle door prohibits the vehicle door from being fully opened, opening the vehicle door to the intermediate position reduces incidents of unwanted damage to the vehicle door, to an adjacent vehicle, or both.

Known door checks for vehicle doors commonly include a roller mounted to the vehicle door and a check arm mounted to the vehicle body. The check arm is generally contoured for engagement with the roller, and is typically formed to include one or more detent notches and/or raised undulations at pre-established locations to facilitate maintaining the door in the pre-established locations, as desired. The roller is typically biased into engagement with the arm via a spring member, wherein the spring member causes the roller to roll along the contoured check arm under a spring force complying with Hooke's law: F=kx, where F is equal to the spring force; k is a spring constant, and x is equal to a linear displacement (axial contraction or expansion) of the spring member. As such, the force applied by the spring is limited to a linear increase and decrease. As the door is being opened, the door will remain in a fully opened or pre-established, partially opened position under normal conditions (wherein the vehicle is on a level, non-inclined surface and the conditions are not windy) upon the roller being disposed in one of the pre-established detent notches under the bias of the spring member. Although these door checks can improve the ability to maintain the vehicle door in a select, pre-established open position, they have drawbacks with the spring member being limited to applying straight, linearly graduated spring force. If the spring force is too weak based on the condition(s), the door is prone to be inadvertently moved from the desired position, such as by being blown open or closed by high force gusts of wind and/or under the force of gravity if the vehicle is on a steep incline. On the other hand, if the bias force is too strong for the condition, the vehicle door is difficult to move between the fully opened and fully closed positions, and can further result in undesirable wear and noise while being opened and closed.

In view of the above, there remains a need to develop a door check which addresses and overcomes challenges associated with known door checks as well as to provide increased applicability while minimizing cost and complexity.

### SUMMARY

This section provides a general summary of the present disclosure and is not a comprehensive disclosure of its full scope or all of its features, aspects and objectives.

It is an aspect of the present disclosure to provide a power-operated, continuously variable force door check mechanism for a vehicle closure system which is operable for continuously varying the force of the door check mechanism to optimize movement of a vehicle closure panel between open and closed positions relative to a vehicle body.

It is a further related aspect of the present disclosure to provide the power-operated variable force door check mechanism for use with a vehicle swing door that is pivotally attached to at least one of an A-pillar (front door application) and/or B-pillar (rear door application).

It is another aspect of the present disclosure to provide a power-operated, variable force door check mechanism that can be effectively mounted within the internal cavity of the vehicle swing door and configured to cooperatively interact with an elongate check arm having an end pivotally connected to the vehicle body.

It is a further related aspect of the present disclosure to provide the power-operated, variable force door check mechanism having a continuously variable force application member configured to selectively vary the force, in a non-linear fashion, applied to the elongate check arm while the vehicle swing door is being pivoted between opened and closed positions.

It is a further related aspect of the present disclosure to provide the continuously variable force application member as a spring member configured in communication with an adjuster, with the adjuster being configured to selectively vary the force applied by spring member to the elongate member while the vehicle swing door is being pivoted between opened and closed positions.

It is a further related aspect of the present disclosure to provide the adjuster of the power-operated, variable force door check mechanism as a linear actuator configured in operable communication with an electronic control unit (ECU) to selectively adjust the force applied to the check arm by the spring member in response to environmental conditions (e.g. inclination of the vehicle, wind conditions, initial door opening condition, imminent vehicle impact with an object) either before the vehicle swing door has been opened and/or while the vehicle swing door is being pivoted between opened and closed positions.

It is a further related aspect of the present disclosure to provide the adjuster of the power-operated, variable force door check mechanism as a actuator configured in operable communication with an electronic control unit (ECU) to selectively adjust the force applied to the check arm by the spring member in response to at least one of door movement, such as acceleration, and position either before the vehicle swing door has been opened and/or while the vehicle swing door is being pivoted between opened and closed positions.

It is a further related aspect of the present disclosure to selectively adjust the force applied to the check arm by the spring member, such that the force applied by the spring member varies in a non-linear fashion, as the vehicle swing door is being pivoted between opened and closed positions.

It is a further related aspect of the present disclosure to provide the power-operated, variable force door check mechanism as being readily interchangeable with an existing mechanical door check and being mountable to an existing mount structure thereof without having to customize the existing mount structure.

It is another aspect of the present disclosure to provide a power-operated variable force door check mechanism including at least one continuously variable force application member configured to apply a force on an elongate member attached to a vehicle closure panel while the vehicle closure panel is being moved between opened and closed positions. The mechanism has an adjuster configured in operable communication with the at least one continuously variable force application member, and a motor configured in operable communication with the adjuster. The motor is selectively energizable to cause the adjuster to move and vary the force applied by the at least one continuously variable force application member on the elongate member.

It is a further related aspect of the present disclosure to provide the at least one continuously variable force application member including a plurality of spring members coaxially aligned with one another across opposite surfaces of the elongate member.

It is a further related aspect of the present disclosure to include a pair of engagement members, with a separate one of the engagement members being disposed between a separate one of the spring members and a separate one of the opposite surfaces of the elongate member to facilitate smooth, low friction sliding movement of the adjuster along the opposite surfaces of the elongate member.

It is a further related aspect of the present disclosure to provide the adjuster as a linear actuator including a pair of screws extending in parallel relation with one another on opposite sides of the elongate member and a plurality of drive nuts configured for translation along the screws.

It is a further related aspect of the present disclosure to provide the plurality of drive nuts including a pair of lower drive nuts interconnected with one another by a lower pusher member and a pair of upper drive nuts interconnected with one another by an upper pusher member, with the lower pusher member engaging one of the pair of spring members and the upper pusher member engaging the other of the pair of spring members.

It is a further related aspect of the present disclosure to provide each one of the pair of screws including a right-hand helical thread region and a left-hand helical thread region, with the pair of lower drive nuts being in threaded engagement with one of the right-hand helical thread regions the left-hand helical thread regions and the pair of upper drive nuts being in threaded engagement with the other of the right-hand helical thread regions and the left-hand helical thread regions.

It is a further related aspect of the present disclosure to configure the at least one screw for translation to contract the at least one spring member to increase the force of the at least one spring member upon the at least one nut being rotated in a first direction and allowing the at least one spring member to expand to decrease the force of the at least one spring member upon the at least one nut being rotated in a second direction opposite the first direction.

It is another aspect of the present disclosure to provide a power-operated variable force door check system including at least one continuously variable force application member configured to apply a force on an elongate member configured to move a vehicle closure panel between open and closed positions. The system further incudes an adjuster configured in operable communication with the at least one continuously variable force application member and a motor configured in operable communication with the adjuster. Further, an electronic control module is configured in electrical communication with the motor, wherein the motor is energizable in response to a signal from the electronic control module to selectively adjust the force applied to the elongate member by the at least one continuously variable force application member. Further, an electronic control module integrated within an electronic vehicle latch is configured in electrical communication with the motor, wherein the motor is energizable in response to a signal from the electronic control module to selectively adjust the force applied to the elongate member by the at least one continuously variable force application member.

It is another aspect of the present disclosure to provide a method of controlling movement of a closure panel of a vehicle. The method includes, providing an elongate member having a proximal end, for coupling the elongate member to one of the closure panel and a body of a vehicle and, a distal end, for coupling the elongate member to the other of the closure panel and the body of the vehicle. Further, controlling a motor to move at least one continuously variable force application member to vary a force applied on the elongate member in response to a signal supplied from an electronic controller.

It is a further related aspect of the present disclosure wherein the step of controlling the motor includes increasing the force applied on the elongate member to one of preventing or reducing movement of the closure panel in response to the electronic controller detecting an acceleration of the vehicle closure panel above a predetermined threshold.

It is a further related aspect of the present disclosure wherein the step of controlling the motor includes decreasing the force applied on the elongate member to allow movement of the closure panel in response to the electronic controller detecting an acceleration of the vehicle closure panel below a predetermined threshold.

It is a further related aspect of the present disclosure to further include the step of determining the inclination of the vehicle closure panel relative to a level, horizontal ground surface and controlling the motor to vary the force applied on the elongate member in response to the determined positive or negative inclination of the vehicle closure panel.

It is a further related aspect of the present disclosure wherein the step of controlling the motor includes increasing the force applied on the elongate member to impart movement to the elongate member to move closure panel in response to the electronic controller detecting an indication from a user and/or environmental condition (inclination, wind, etc.) to move the closure panel.

It is a further related aspect of the present disclosure to further include the step of determining the position of the vehicle closure panel corresponding to a nearly closed position and controlling the motor to increase the force applied on the elongate member in response to the determined position of the vehicle closure panel.

It is a further related aspect of the present disclosure to increase the force applied on the elongate member in response to the determined position of the vehicle closure panel corresponding to a nearly closed position to urge the vehicle closure panel to a fully closed position in a cinching operation.

It is another aspect of the present disclosure to provide a closure panel actuation system for moving a closure panel about an axis, from a partially open position to a fully closed position relative to a vehicle body. The swing door actuation system includes a latch provided on one of the closure panel and the vehicle body, with the latch including an electronic control unit, wherein the latch is configured to engage a striker provided on the other one of the closure panel an vehicle body, and also configured to retain the striker in one of a secondary striker position when the door is in the partially open position and a primary latch position when the closure panel is in the fully closed position. The swing door actuation system further includes a power-operated variable force door check mechanism including: at least one continuously variable force application member configured to apply a force on an elongate member attached to a vehicle closure panel while the vehicle closure panel is being moved between opened and closed positions. The swing door actuation system further includes an adjuster configured in operable communication with the at least one continuously variable force application member; and a motor configured in operable communication with the adjuster. The motor is selectively energizable in response to receiving a signal from the electronic control unit and in response to the latch engaging the striker in the secondary striker position to cause the adjuster to move and increase the force applied by the at least one continuously variable force application member on the elongate member to move the closure panel to the fully closed position.

Further areas of applicability will become apparent from the description provided herein. The description and specific embodiments listed in this summary are for purposes of illustration only and are not intended to limit the scope of the present disclosure.

### BRIEF DESCRIPTION OF THE DRAWINGS

These and other objects, features and advantages of the present disclosure will be readily appreciated by one possessing ordinary skill in the art, as the same becomes better understood by reference to the following detailed description when considered in connection with the appended claims and accompanying drawings, wherein:

FIG. 1 is a perspective view of an example motor vehicle equipped with a power-operated variable force door check mechanism constructed in accordance with the teachings of the present disclosure;

FIG. 2 is schematic side view of a power-operated variable force door check mechanism in accordance with the teachings of the present disclosure;

FIG. 3 is a cross-sectional top view through a portion of a vehicle door and adjacent door pillar, with the door shown in a closed position, showing a power-operated variable force door check mechanism in accordance with the teachings of the present disclosure;

FIG. 4 is a view similar to FIG. 3, with the door shown in an open position;

FIG. 5 is a front perspective view of a power-operated variable force door check mechanism in accordance with another aspect of the teachings of the present disclosure;

FIG. 5A is a rear perspective view of the power-operated variable force door check mechanism of FIG. 5;

FIG. 6 is a view similar to FIG. 5A with a housing removed from the power-operated variable force door check mechanism to show an adjuster thereof;

FIG. 7 is a side view of a portion of the power-operated variable force door check mechanism of FIG. 6 showing the adjuster in a force decreasing expanded state; and

FIG. 8 is a view similar to FIG. 7 showing the adjuster in a force increasing contracted state;

FIGS. 9 and 10 are a sequence of side views of a portion of the power-operated variable force door check mechanism of FIG. 6 showing the adjuster in a force increasing state to impart a movement of the elongated member to move the closure panel towards a fully closed position;

FIGS. 11 and 12 are a sequence of side views of a portion of the power-operated variable force door check mechanism of FIG. 6 showing the elongated member having a tapered profile with the adjuster in a force increasing state to impart a movement of the elongated member to move the closure panel towards an open position;

FIG. 13 is a closure panel actuation system, in accordance with an illustrative embodiment; and

FIG. 14, is a flow diagram of a method of controlling movement of a closure panel of a vehicle, in accordance with an illustrative embodiment.

### DETAILED DESCRIPTION OF EXAMPLE EMBODIMENTS

In general, at least one example embodiment of a power-operated variable force door check mechanism and system therewith having a variable force application member constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

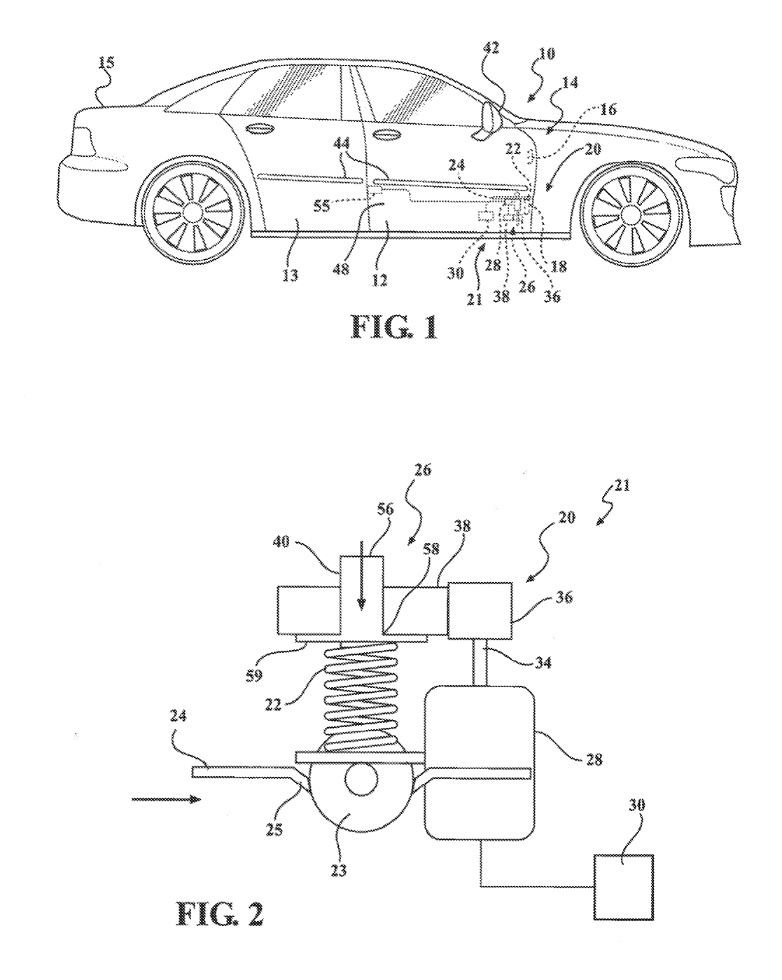

Referring initially to FIG. 1, an example motor vehicle 10 is shown to include closure panels, such as front and rear passenger doors 12, 13, by way of example and without limitation, with the front door 12 being illustrated as being pivotally mounted to a vehicle body 14 via an upper door hinge 16 and a lower door hinge 18, which are both shown in phantom lines. In accordance with a general aspect of the present disclosure, a power-operated variable force door check mechanism 20, referred to hereafter simply as mechanism 20, also shown in part in phantom lines, is integrated in a vehicle closure system 21 for operable communication with the pivotal connection between front passenger door 12 and a vehicle body 14. In accordance with a preferred configuration, the mechanism 20 of vehicle closure system 21 generally includes a continuously variable force application member 22 configured to selectively vary the force, in non-linear fashion, applied to an elongate member 24, also referred to as check arm, while the vehicle door 12 is being pivoted between opened and closed positions. Illustratively, the elongate member 24 may be provided with one or more detents 25 for receipt of a first roller 60 or shaft or other type of engagement member for checking the door at such a position corresponding to the position of the detent 25. The continuously variable force application member 22 is configured in communication with an adjuster 26, wherein the adjuster 26 is configured in operable communication, via an intervening motor 28, with an electronic control module (ECM) 30 to selectively adjust the force applied to the check arm 24 by the continuously variable force application member 22. The ECM 30 may be provided as part of the main vehicle electronic control unit (ECU), and/or from a separate control unit, such as an ECU in a vehicle door latch assembly 15, by way of example and without limitation.

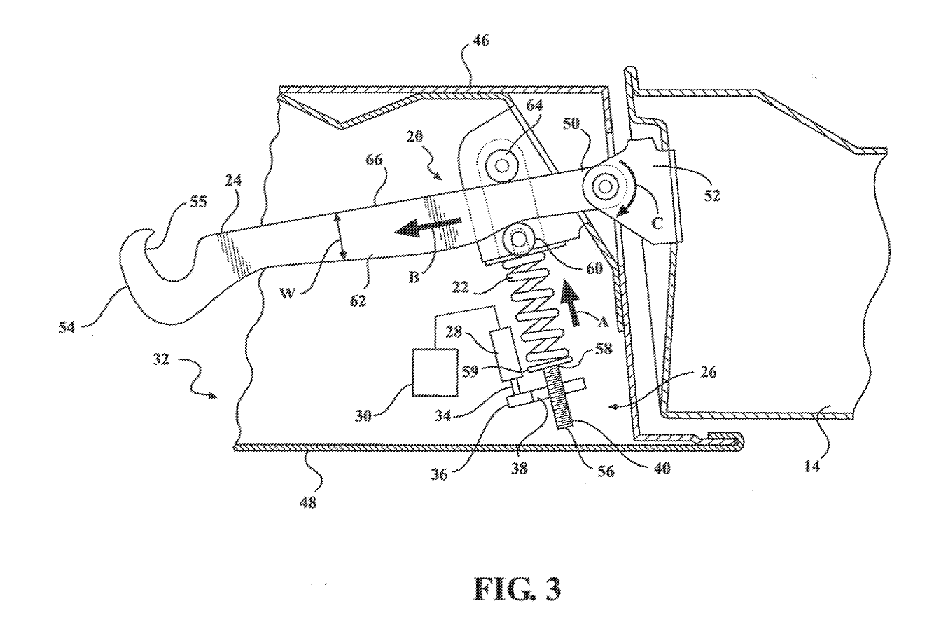

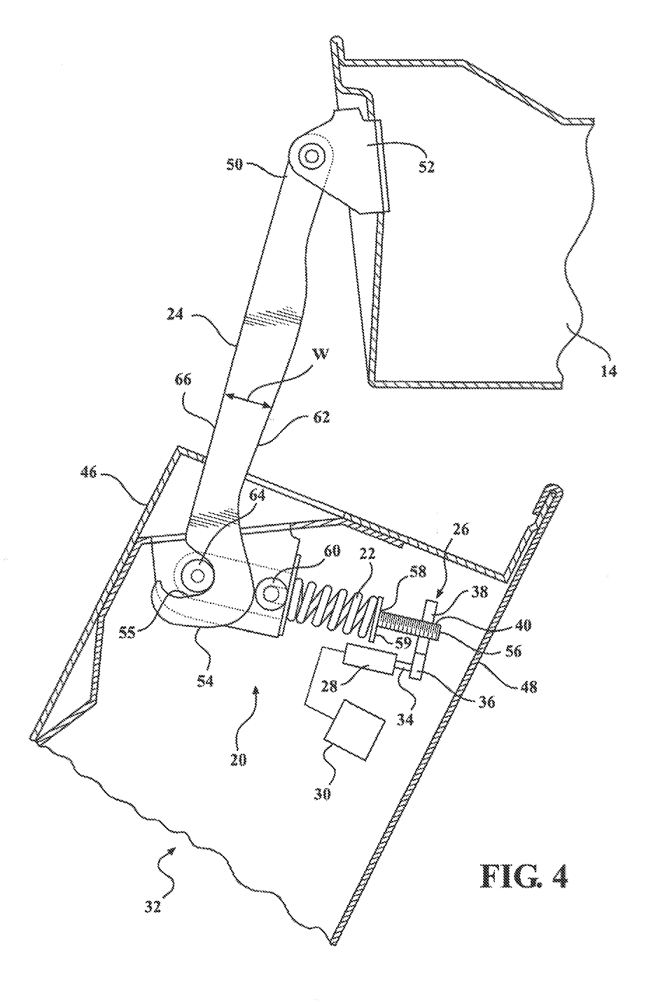

The mechanism 20 is secured, at least in part, within an internal cavity 32 (FIGS. 3-4) of passenger door 12. The motor 28 can be provided as an electric motor 28, by way of example and without limitation, and can be configured to drive a rotary driven member, such as a shaft 34 having a drive member, such as a gear member 36, in a non-limiting embodiment, connected thereto for rotation in response to selective actuation of the motor 28. The gear member 36 is arranged in driving communication with the adjuster 26, and in one non-limiting embodiment, the adjuster 26 can be provided as a linear actuator including a drive nut 38 configured for engagement with a driven member, such as a threaded screw 40, such that rotation of the drive nut 38 causes linear translation of the screw 40, which in turn results in varying the force applied by the continuously variable force application member 22 on the check arm 24. As such, the resistance to pivoting movement of the door 12 fostered by the force of the adjuster 26 applied on the check arm 24 can be continuously varied, as desired, via selective actuation of the motor 28, as discussed in more detail hereafter. It is to be recognized that the adjuster 26 may include other than a linear actuator, such as a solenoid actuator or otherwise, such as will be recognized by one skilled in the art upon viewing the present disclosure.

Each the upper door hinge 16 and lower door hinge 18 include a door-mounting hinge component and a body-mounted hinge component that are pivotably interconnected by a hinge pin or post, as is known. While the mechanism 20 is only illustrated in association with front passenger door 12, those skilled in the art will recognize and understand that the mechanism 20 can also be associated with any other closure panel of vehicle 10 such as, by way of example and without limitation, a liftgate, the rear passenger doors 13 and deck lid 15.

Mechanism 20 is shown in FIGS. 2-4 to include the electronic control module 30 configured in electrical communication with electric motor 28 for providing electric control signals thereto. Electronic control module 30 can include a microprocessor and a memory having executable computer readable instructions stored thereon, as will be appreciated and understood by one skilled in the art.

Electronic control module 30 can receive an input from one or more sensors, such as an ultrasonic sensor in accordance with one non-limiting embodiment, located on the vehicle door 12, such as on an exterior surface of the vehicle 10, for example, on a door mirror 42 and/or an outer trim members 44, and the like. Ultrasonic sensor(s) can assess if an obstacle, such as another car, tree, pedestrian, post, or the like, is near or in close proximity to vehicle door 12 such that it may impact the vehicle 10. If such an obstacle is present, ultrasonic sensor will send a signal to electronic control module 30, and electronic control module 30 will proceed to command the motor 28 to actuate the adjuster 26 of the mechanism 20 to increase or maximize the force applied by the continuously variable force application member 22 on the check arm 24, thereby temporarily restricting or preventing movement of vehicle door 12. This provides a mechanism to prevent unwanted, inadvertent opening of the door 12, such as in an accident situation, by way of example and without limitation, whereupon after impact, the sensor can send a different signal to return the mechanism 20 to a normal operating mode allowing the door 12 to be intentionally opened, as desired. In addition, or optionally, a sensor, such as a position sensor, can be provided to detect an initial door opening event, whereupon the motor 28 can be commanded to actuate the adjuster 26 to temporarily increase the force applied by the continuously variable force application member 22 on the check arm 24, thereby reducing or eliminating an effect known in the art as “door pop”, which is a sudden popping noise sometimes produced from the door 12 suddenly pulling away from a door seal. Accordingly, smooth, gentle and substantially noise free opening of the door 12 can be attained. Further yet, sensors can be provided as accelerometers, thus, being able to detect sudden accelerations of the door 12, such as might be encountered on steep hill or in windy conditions during door opening and closing, or by a user door slam, by way of examples and without limitation, wherein the sensor can send a signal to energize the motor 28, thereby causing the adjuster 26 to be actuated to increase the force applied by the continuously variable force application member 22 on the check arm 24, thereby preventing the door 12 from being swung suddenly and wildly open or closed violently under the force of gravity, a user intentionally slamming the door 12, or wind. Such an accelerator (e.g. Accelerometer 155) may be provided at a position as remote from the hinge axis of the vehicle door e.g. hinges 12, 13, and as an example, as provided on the control circuity integrated into e-latch assembly 55 positioned away from the hinges 12, 13 to maximize sensitivity of any closure panel movement. Accordingly, in view of the several examples above, one skilled in the art will readily appreciate these and other scenarios where the mechanism 20 can be activated via communication with the ECM 30 to suddenly adjust the magnitude of resistance applied to the check arm 24 to facilitate an ability to open and close the door 12 in a soft, smooth, easy and gentle fashion, regardless of environmental conditions, as discussed further hereafter.

The swing door 12 includes inner and outer sheet metal panels 46 and 48 defining the internal cavity 32. The mechanism 20 may be mounted within the internal cavity 32, as noted above. A first terminal end, also referred to as proximal end 50, of check arm 24 is shown pivotally mounted to the vehicle body 14, such as to an A-pillar and/or B-pillar via a mount bracket 52, by way of example and without limitation, wherein the check arm 24 extends generally horizontally to a second terminal end, also referred to as distal end 54. The check arm 24 is shown as having a varying width (W) along its length and a generally hook-shaped pocket 55 that serves as a stop feature to prevent the door 12 from being opened beyond a predetermined position. As such the mechanism 20 can be used not only to vary the force applied to the check arm 24 during translation relative thereto, but also can be used as a locking mechanism to displace a moveable locking feature e.g. second roller 64 from a locking detent e.g. pocket 55. Upon viewing the entirety of the disclosure herein, one skilled in the art will recognize that the shape of the check arm 24 can be modified as desired, including having a constant width W, if desired, as the width W of the check arm 24 is not required to change to affect the opening and closing operation of the door 12, due to the ability of the mechanism 20 to vary the force applied to the check arm 24, thereby simplifying construction and reducing the cost associated with the check arm 24.

The mechanism 20 is configured for incorporation into an existing door structure and door system without need for modification, though the check arm in the existing door could be changed, if desired. The adjuster 24 (drive nut 38 and screw 40), motor 28 (with shaft 34 and drive member 36), and ECM 30 can all be mounted and supported within the internal cavity 32 of the door 12, such as via attachment to the inner panel 46, by way of example and without limitation.

The drive nut 38 can be provided being fixed against axial movement for rotation in response to driven rotation of the drive member 36. As such, the drive member 36 can be provided as a gear in meshed engagement with an outer surface of the drive nut 38, by way of example and without limitation. It is contemplated herein that mechanisms of engagement between the drive member 36 and drive nut 38 could be utilized other than meshed teeth, such as any suitable high frictional engagement member or mechanism therebetween, such as a rubberized surface, belt, chain or the like, sufficient to cause concurrent rotation of drive nut 38 in response to the motor 28 driving the drive member 36. The drive nut 38 has a threaded through bore sized for receipt of the screw 40 therethrough, wherein the drive nut 38 and screw 40 can be provided as a lead screw assembly with corresponding mating threads, or they can be provided as a ball screw assembly having balls received in aligned internal and external helical grooves, if desired, as will be readily understood by one possessing ordinary skill in the art. Accordingly, with the drive nut 38 being fixed against translation, the screw 40 translates back and forth, toward and away from the continuously variable force application member 22, in response to a selectively actuated rotation of the drive nut 38 in clockwise and counterclockwise directions.

The screw 40 has a free proximal or first end 56 and an opposite distal or second end 58. The second end 58 is configured having an enlarged pusher member or plate, and referred hereafter as pusher 59, thereon or adjacent thereto. The pusher 59 is located for operable engagement with the continuously variable force application member 22, such as a coil spring member 22, by way of example and without limitation. As such, as the screw 40 is translated toward the spring member 22, the pusher 59 causes the spring member 22 to be compressed, thereby increasing the force of the spring member 22 acting operably (directly or indirectly via an intermediate member 23, illustratively shown as a roller in FIG. 2) on the check arm 24. As shown in a non-limiting embodiment of FIGS. 3 and 4, the spring member 22 can be configured to act on a first engagement member, such as a first roller 60 or shaft thereof to bias the first roller 60 into engagement with one engagement surface, referred to as a lower surface 62, of the check arm 24, while a second engagement member, such as a second roller 64, can be fixed for rolling engagement with an opposite engagement surface, referred to as upper surface 66, of the check arm 24 to capture the check arm 24 for translation between the rollers 60, 64. It is to be recognized that the force with which the first roller 60 engages the lower surface 62 of check arm 24 increases and decreases, respectively, as the spring member 22 is axially compressed and expanded. Accordingly, as the spring member 22 is axially compressed, the resistance to translation of the check arm 24 between the rollers 60, 64 is increased to a stiffened state, and as the spring member 22 is axially expanded, the resistance to translation of the check arm 24 between the rollers 60, 64 is decreased to a relaxed state, such that the stiffness is greater in the stiffened state relative to the relaxed state. It is to be further recognized that the use of rollers is non-limiting, and that a suitable low-friction member(s), such as a skid plate(s) or the like, could be incorporated, such a member(s) of PTFE, or other suitable lubricious material. Optionally, a suitable medium to high friction generating member, such as a friction pad composite of a low noise friction generating material, as but an example, may be provided such that the spring member 22 can be reduced in size while the mechanism 20 can provide the various door checking functionality as described herein.

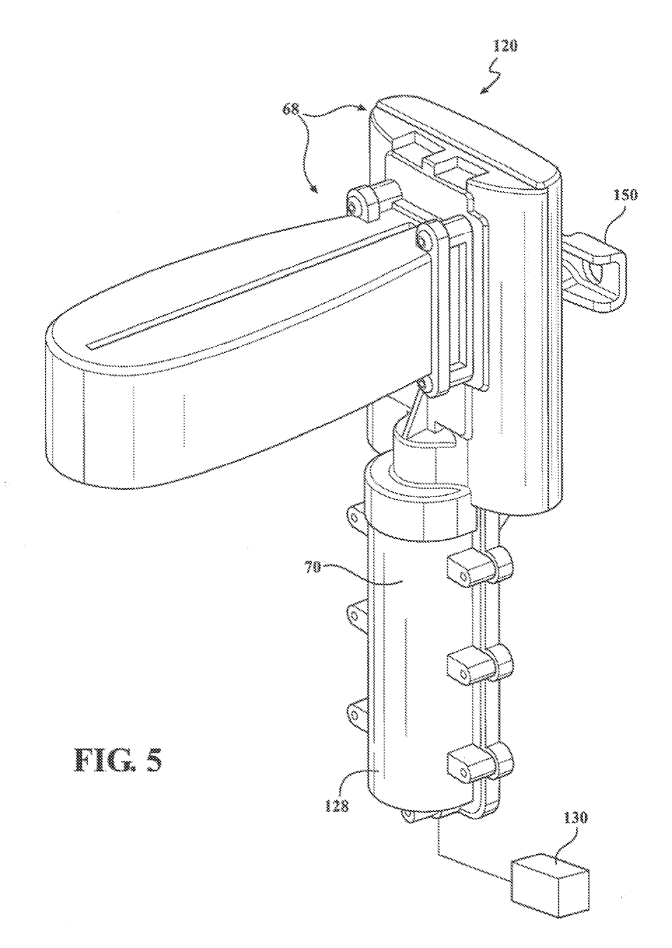

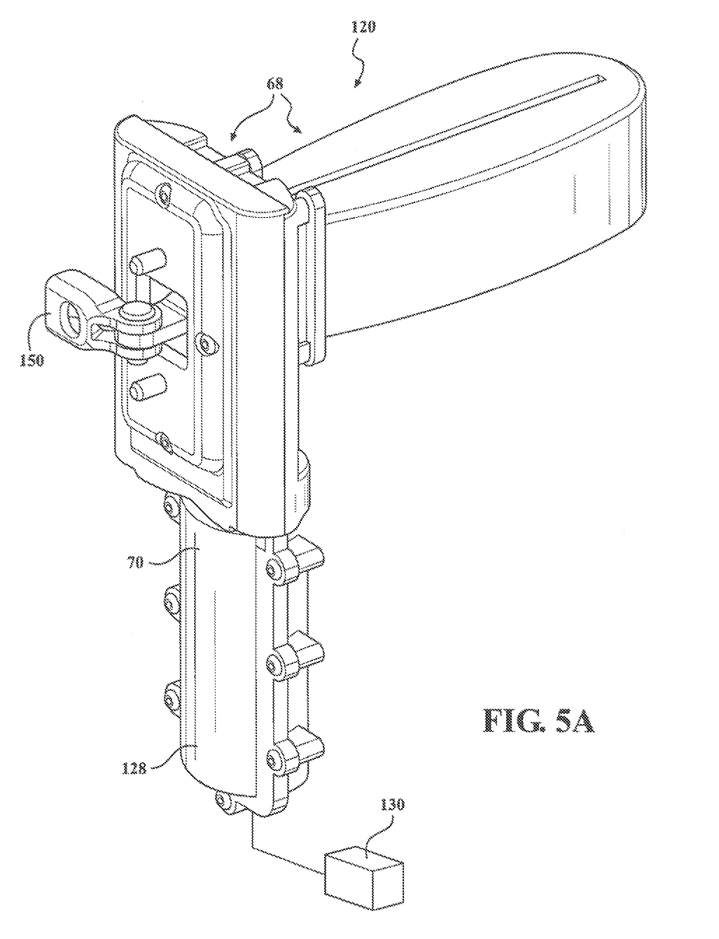

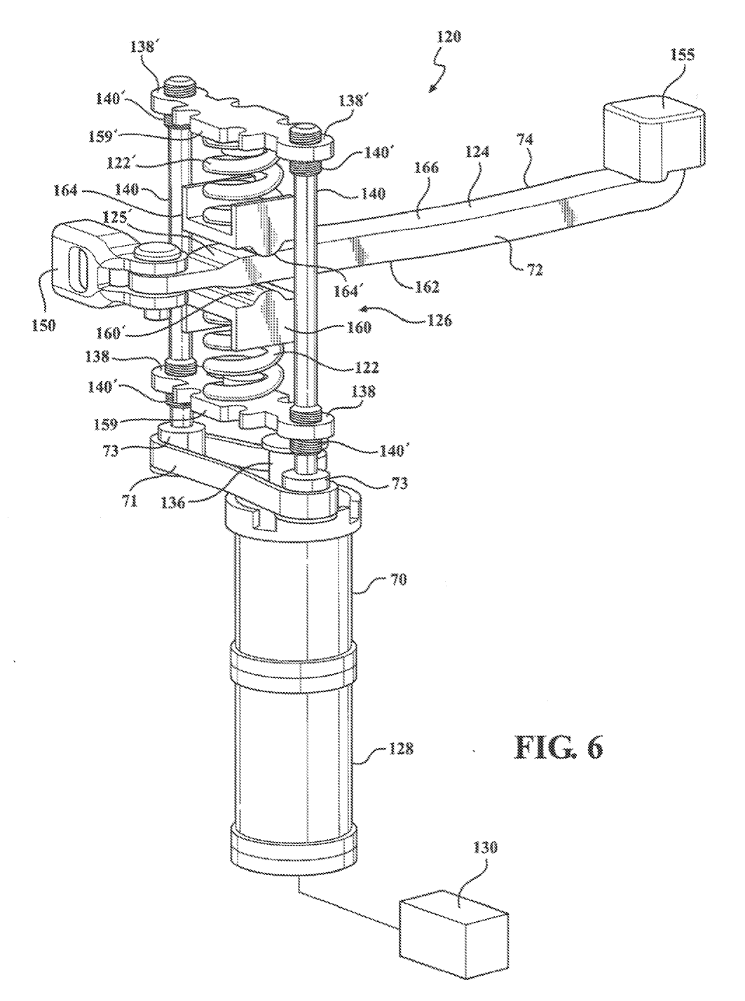

In FIGS. 5-8, a power-operated variable force door check mechanism 120, referred to hereafter simply as mechanism 120, constructed in accordance with another aspect of the present disclosure, operable for incorporation into vehicle closure system 21 as generally discussed above for mechanism 20, is shown for operable communication with the pivotal connection between front passenger door and a vehicle body, such as discussed above for vehicle door 12 and vehicle body 14, by way of example and without limitation, wherein the same reference numerals as used above, offset by a factor of 100, are used to identify like features. In FIGS. 5 and 5A, a housing assembly 68 is shown enclosing internal components of mechanism 120, while in FIGS. 6-8, housing assembly 68 is removed for discussion of the internal components. In accordance with a preferred configuration, the mechanism 120, as shown in FIGS. 6-8, generally includes at least one, and shown as a plurality, and in accordance with one exemplary aspect, a pair of continuously variable force application members, referred to hereafter as lower force application member 122 and upper force application member 122′, configured to selectively vary the force, in linear and non-linear fashion, as necessary, applied to an elongate member 124, also referred to as check arm or arm, while the vehicle door 12 is being pivoted between opened and closed positions. The continuously variable force application members 122, 122′ are configured in communication with an adjuster 126, wherein the adjuster 126 is configured in operable communication, via an intervening motor 128, with an electronic control module (ECM) 130 to selectively adjust the force applied to the check arm 124 by the force application members 122, 122′. The ECM 130, as discussed above for ECM 30, may be provided as part of the main vehicle electronic control unit (ECU), and/or from a separate control unit, such as an ECU in a vehicle door latch assembly 55, such as an electronic latch similar to the likes disclosed in US patent application US 2017/0107747, filed Oct. 6, 2016, and entitled “Electrical Door Latch,” the entirety of which is incorporated herein by reference, or e-latch integrating an electronic control unit and control logic and instructions for control of the door latch and other internal and external components, by way of example and without limitation. ECM 130 can further be provided, as discussed above, to include a microprocessor and a memory having executable computer readable instructions stored thereon, as will be appreciated and understood by one skilled in the art, and can receive an input from one or more sensors 151, such as an ultrasonic sensor, a position sensor 153, and an accelerometer 155, in accordance with several non-limiting embodiment, located on the vehicle door 12, such as on an exterior surface of the vehicle 10, for example, on a door mirror 42 and/or an outer trim members 44, and the like. Given the discussion above regarding ECM 30, which is equally applicable here, further discussion here for ECM 130 is believed unnecessary, as one possessing ordinary skill in the art will readily understand such without repetition.

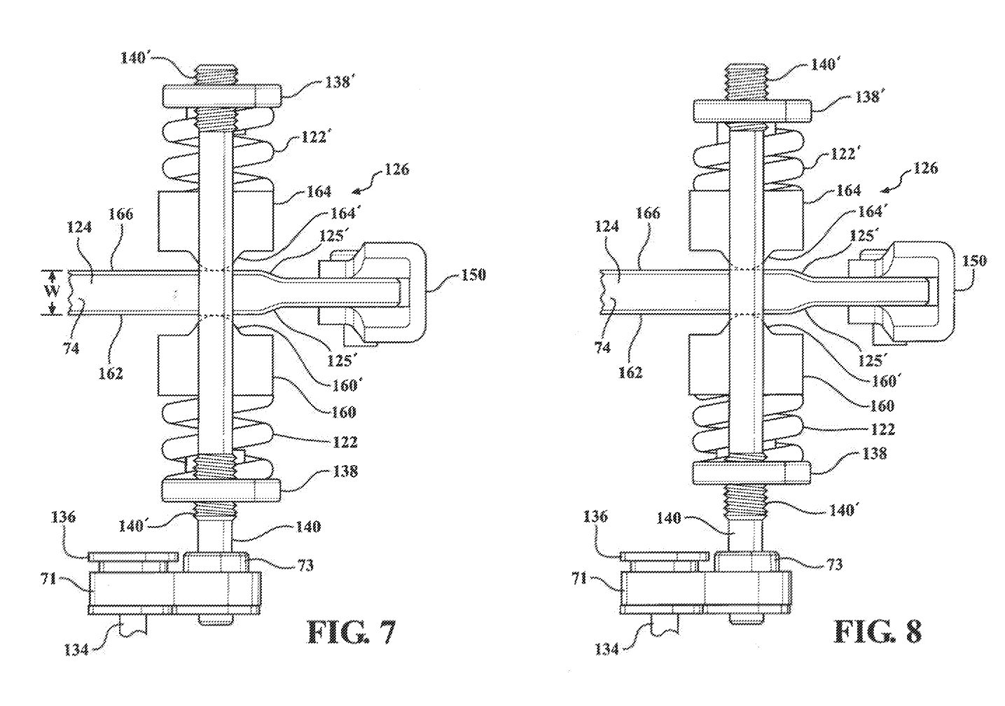

The motor 128 can be provided as discussed above for motor 28, such as an electric motor 128, by way of example and without limitation, and can be configured to be selectively energized to drive a rotary driven member, such as a shaft 134 (FIGS. 7 and 8) having a drive member, such as a sprocket, timing-belt gear or pulley member 136, in a non-limiting embodiment, connected thereto for rotation in response to selective actuation of the motor 128. An intermediate gearing, such as a reduction gear train set 70 can be provided between motor 128 and pulley member 136, if desired, thereby allowing a reduced, minimal size motor 128 to be used. The pulley member 136 is arranged in driving communication with the adjuster 126, such as via a continuous drive member 71, such as a belt, chain or the like, wherein the drive member 71 is configured driving relation with a separate driven member 73. In one non-limiting embodiment, the adjuster 126 can be provided as a linear actuator including a plurality of driven members, also referred to as drive nuts, shown as lower drive nuts 138 and upper drive nuts 138′, configured for engagement with a plurality, and shown as a pair, by way of example and without limitation, of drive members, such as a pair of threaded screws 140. Rotation of the screws 140, via driven members 73 being fixed thereto, causes linear translation of the lower and upper drive nuts 138, 138′ along externally threaded regions 140′ of the screws 140, wherein the lower drive nuts 138 are either driven toward or away from the upper drive nuts 138′, depending on the direction of rotation of the screws 140, as determined by the direction of driven rotation of the drive member 71 by motor 128. Translation of the lower and upper drive nuts 138, 138′ along the threaded regions 140′ results in varying the force applied by the continuously variable force application members 122, 122′ on the check arm 124. The lower drive nuts 138 traverse along the externally threaded regions 140′, which are either left-hand (LH) or right-hand (RH) helically treaded, while upper drive nuts 138′ traverse along the externally threaded regions 140′, which are an opposite-hand helical tread to the threaded regions 140′ of the lower drive nuts 138. Accordingly, if the externally threaded regions 140′ in threaded engagement with the lower drive nuts 138 are LH helical threads, then the externally threaded regions 140′ in threaded engagement with the upper drive nuts 138′ are RH helical threads, and vice versa. As such, the resistance to pivoting movement of the door 12 as a result of the force of the adjuster 126 applied on the check arm 124 can be selectively and continuously varied, as desired, via selective actuation of the motor 128 via signals from the ECM 130. It is to be recognized that the adjuster 126 may include other than a linear actuator, such as a solenoid actuator or otherwise, such as will be recognized by one skilled in the art upon viewing the present disclosure.

The check arm 124, as discussed above for check arm 24, has a first terminal end, also referred to as proximal end 150, pivotally mounted to the vehicle body 14, such as to an A-pillar and/or B-pillar via a mount bracket 52, by way of example and without limitation, wherein the check arm 24 extends generally horizontally to a second terminal end, also referred to as distal end 154. The check arm 24 is shown as having a generally constant width (W) (FIG. 7) along its length and a raised feature 155 extending outward from at least one of the lower and upper surfaces 162, 166, shown as extending outwardly from the upper surface 166, by way of example and without limitation, that serves as a stop feature to prevent the door 12 from being opened beyond a predetermined position.

The pair of screws 140 are arranged to extend in generally parallel relation with one another across opposite sides 72, 74 of the check arm 124. One pair of drive nuts 138 are interconnected with one another via a lower pusher member, also referred to as pusher plate or lower pusher 159, while another pair of drive nuts 138′ are interconnected with one another via an upper pusher member, also referred to as pusher plate or upper pusher 159′. The lower pusher 159 and drive nuts 138 interconnected thereto, and likewise the upper pusher 159′ and drive nuts 138′ interconnected thereto, can be formed as a monolithic piece of material, such as in a casting, molding, machining, or stamping process, by way of example and without limitation, or they could be constructed as separate pieces of material and fixed together, such as via a welding process or suitable fastening mechanism. The lower pusher 159 extends in facing relation to one engagement surface of check arm 124, referred to as a lower surface 162, in spaced relation therefrom by the lower force application member 122 and a lower or first engagement member 160, while the upper pusher 159′ extends in facing relation to an opposite engagement surface of check arm 124, referred to as upper surface 166, in spaced relation therefrom by the upper force application member 122′ and an upper or second engagement member 164. Accordingly, lower force application member 122 is sandwiched between lower pusher 159 and lower surface 162 of check arm 124, and in particular, between lower pusher 159 and lower engagement member 160, and upper force application member 122′ is sandwiched between upper pusher 159′ and upper surface 166 of check arm 124, and in particular, between upper pusher 159′ and upper engagement member 164. First engagement member 160 and second engagement member 164 are shown facing each other with check arm 124 sandwiched therebetween. First engagement member 160 has an arcuate, shown as being a convex and generally semi-cylindrical engagement surface 160′ extending generally from one side 72 to the opposite side 74 of check arm 124 and establishing line contact with lower surface 162 of check arm 124 and second engagement member 164 has an arcuate, shown as being a convex and generally semi-cylindrical engagement surface 164′ arranged in mirrored relation with engagement surface 160′ and establishing line contact with upper surface 166 of check arm 124. Accordingly, the force application members 122, 122′, shown as being co-axially aligned spring members, such as coil springs, by way of example and without limitation, are captured in compressed relation between respective pushers 159, 159′ and first and second engagement members 160, 164 to bias first and second engagement members 160, 164 into engagement with lower and upper surfaces 162, 166, respectively, for sliding movement therealong as vehicle door 12 moves between it open and closed positions. First engagement member 160 and second engagement member 164 can be constructed of any desired polymeric or metal material, as desired, though low-friction sliding engagement with check arm 124 can be facilitated via a low-friction polymeric material. In operation, as the screws 140 are driven concurrently in the desired synchronous counterclockwise or clockwise direction, the lower pusher 159 and upper pusher 159′ are either driven toward one another, thereby increasing the force applied by the first and second engagement members 160, 164 on the lower and upper surfaces 162, 166 of check arm 124, or away from one another, thereby decreasing the force applied by the first and second engagement members 160, 164 on the lower and upper surfaces 162, 166 of check arm 124, as will be understood by a skilled artisan in view of the disclosure herein.

In use, depending on various environmental factors, such as attitude and inclination of the vehicle 10, wind conditions, whether or not the vehicle 10 is moving (whether or not objects, including pedestrians, another vehicle and the like are quickly approaching the vehicle 10 with the risk of imminent impact), by way of example and without limitation, the mechanism 20, 120 can be activated via sensors signaling ECU 30, 130 to energize motor 28, 128 to adaptively increase or decrease the total force (force applied by environmental conditions, e.g. gravity, wind, plus the forced applied by the person opening or closing the door 12) necessary to open and close the door 12 or otherwise regulate the speed at which the door 12 is moving to prevent sudden slamming or sudden opening, such as in a high wind. It is to be further recognized that the force applied by mechanism 20, 120 to check arm 24, 124 can change continuously or incrementally within a single door opening and closing event to alter the total force required to continue opening and closing the door 12, including urging (biasing) the door 12 toward the opened and closed positions (such as in a cinching operation), as desired. Accordingly, the mechanism 20, 120 is continuously variable, such that the force applied thereby may be continuously and adaptively varied while opening and closing the door 12. For example, while initially opening the door 12 from a fully closed state, the spring member 22, 122, 122′ may be axially compressed to impart a relatively high force on check arm 24, 124 to slow the opening of the door 12, thereby minimizing the effect of door pop, while immediately after cracking the door 12 open, the spring member 22, 122, 122′ can be axially expanded to decrease the force needed to continue opening the door 12, thereby allowing the door 12 to be pivoted more easily and quickly with relative ease and little effort required from the user. Of course, as discussed above, if a wind condition is such that the door 12 is caused to open quickly, the sensor detecting the sudden pivotal acceleration of the door 12 caused by the wind can send a signal to the motor 28, 128 to actuate the adjuster 26, 126 to axially compress the spring member 22, 122, 122′, thereby acting to instantaneously increase the applied force of the engagement member 60, 160, 164 on the check arm 24, 124 to dampen and slow the opening of the door 12 under the force of the wind. In other environmental conditions, the adjuster 26, 126 can be actuated to increase or decrease the force applied by the spring member 22, 122, 122′ on the engagement member 60, 160, 164, as needed, and thus, it is to be recognized that the mechanism 20, 120 is instantaneously and automatically operable to facilitate opening, closing and maintaining the door 12 in a desired position, regardless of environmental conditions. Accordingly, the mechanism 20, 120 provides a real-time capacity to incrementally increase and decrease the force applied against the check arm 24, 124, thus, providing an optimal door opening, closing, and holding capability, as desired. It is to be further recognized that the ECM 30, 130 can be programmed to allow separate doors of the vehicle 10 to function differently from one another, given that the separate doors 12 may be subjected to different environmental effects, such as doors on opposite sides of the vehicle 10 being subjected to opposed gravitational affects. As such, although each door 12 may be subjected to different environmental conditions, each door 12 may be opened, closed and maintained in a desired open state with the same relative ease. The power-operated variable force door check mechanism 20, 120 described herein can therefore offer some functionalities provided by a full power door system as known in the art and which typically includes a dedicated extendable and retractable member interconnected between the vehicle and the vehicle body for urging the vehicle door open and closed when respectively extended or retracted, yet the power-operated variable force door check mechanism 20, 120 may provide a mechanism having lower cost, lower weight, and lower packaging dimensions as compared with such a full power door system, and which is also easily integrated into an existing door check footprint and mounting area within a vehicle door.

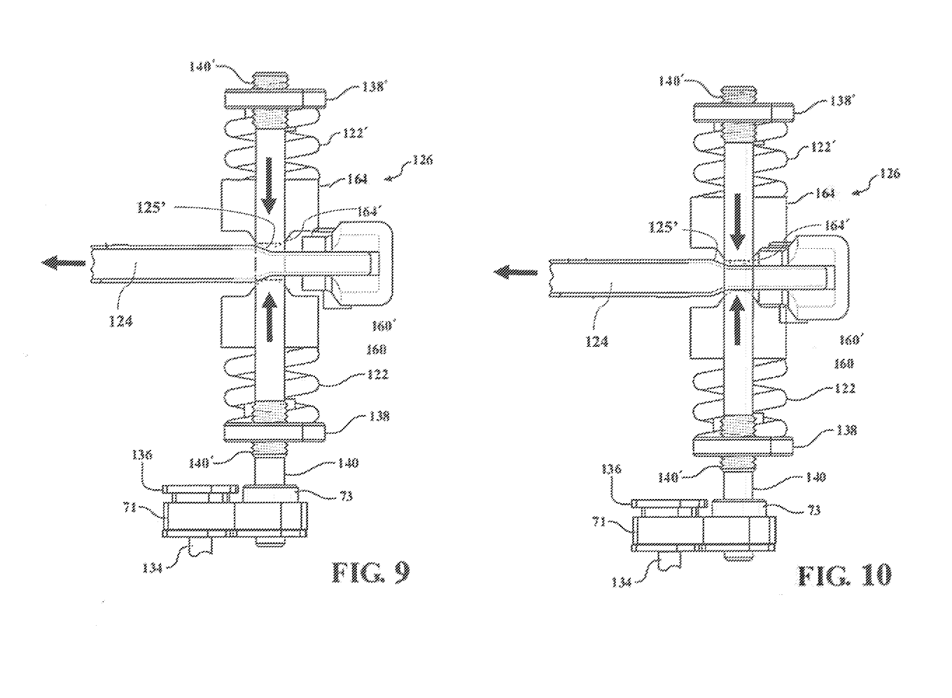

Now referring to FIGS. 9 and 10, there is illustrated a series of views showing an imparted, biased movement of the elongated member 124 in response to the electronic control module (ECM) 130 selectively adjusting the force applied to a negatively sloped portion 125′ of the check arm 124 by the force application members 122, 122′. Negatively sloped portion 125′ is sloped towards proximal end 150 that is pivotally mounted to the vehicle body 14, such that upon the force application members 122, 122′ applying a force along opposite directions, as shown by vertical arrows facing one another, towards the check arm 124, illustratively show in an initial position of FIG. 9 wherein the door 12, 13 corresponds to a partially opened position, the check arm 124 will be urged under the applied forces to impart a motion, along direction of leftward facing arrow, to the closure panel 12, 13 to move the closure panel 12, 13 to a fully closed position, as illustratively shown in FIG. 10. Power-operated variable force door check mechanism 120 can therefore be configured as a power assisted closure panel closing and latch cinching mechanism.

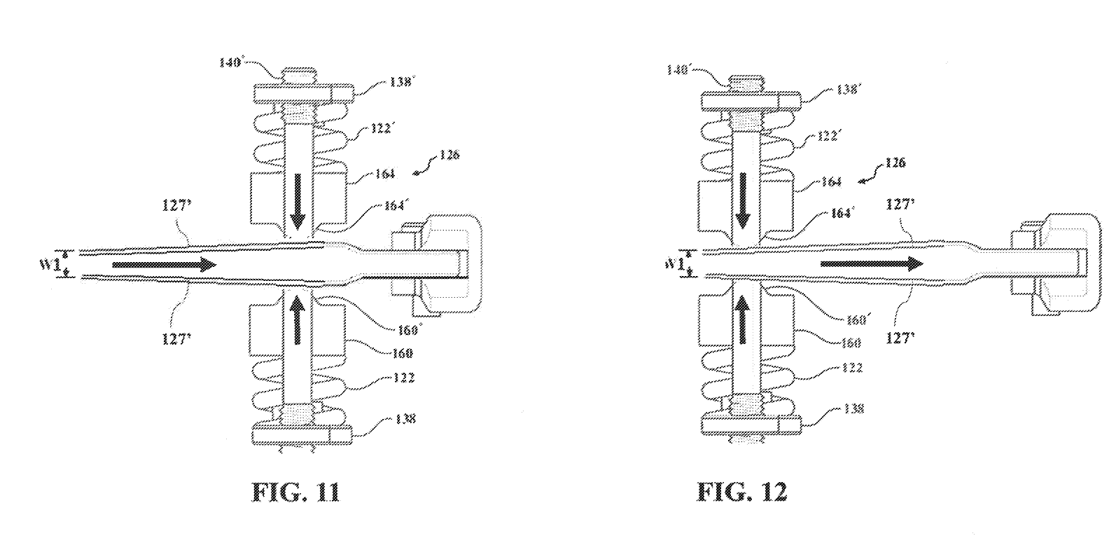

Now referring to FIGS. 11 and 12, there is illustrated a series of views showing an imparted, biased movement of the elongated member 124 in response to the electronic control module (ECM) 130 selectively adjusting the force applied to a positively sloped portion 127′ of the check arm 124 by the force application members 122, 122′. Positively sloped portion 127′ is positively sloped towards proximal end 150 that is pivotally mounted to the vehicle body 14, such that upon the force application members 122, 122′ applying a force, along facing vertical arrows, towards the check arm 124, illustratively show in an initial position of FIG. 11 wherein the door 12, 13 corresponds to a fully closed position, the check arm 124 will be urged under the applied force to impart a motion, along direction of rightward facing arrow, to the closure panel 12, 13 to move the closure panel 12, 13 toward an open position, as illustratively shown in FIG. 12. Power-operated variable force door check mechanism 120 can therefore be configured as a power assisted closure panel opening mechanism.

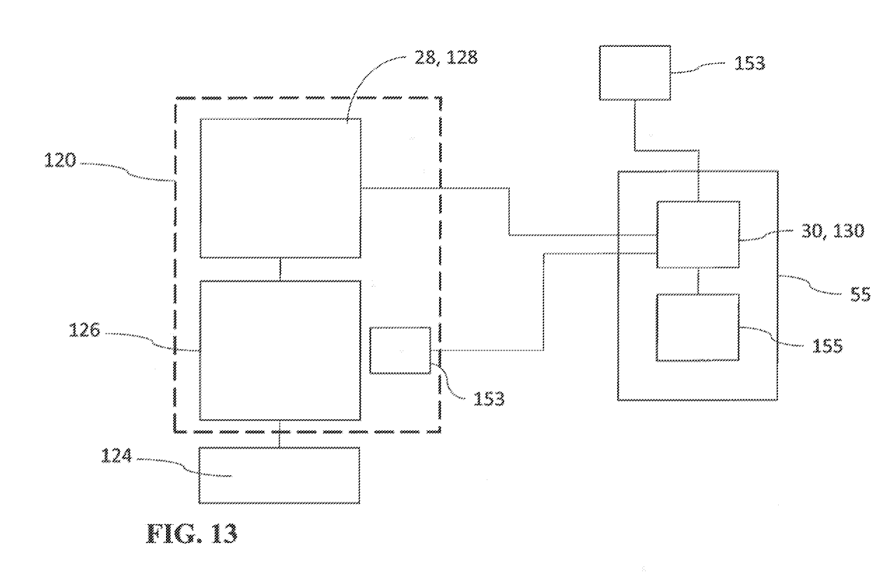

Now referring to FIG. 13, in addition to FIG. 3, there is provided a system for cinching a latch from a secondary latch position to a primary latch position using the power-operated variable force door check mechanism 120, the motor 28, 128 being controlled by the microprocessor provided on the e-latch assembly 55. An increase in the force applied to the door check 124 illustrated by Arrow A (FIG. 3), causing the door check 124 to be drawn in a direction indicated by Arrow B, thereby causing the closure panel 12, 13 to move to a fully closed position as indicated by Arrow C.

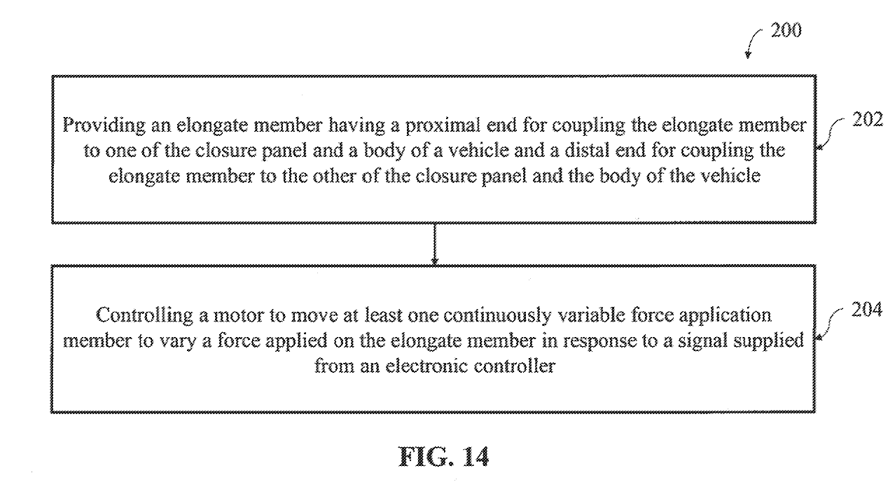

Now referring to FIG. 14, there is provided a method of controlling movement of a closure panel of a vehicle 200, including the steps 202 of providing an elongate member having a proximal end for coupling the elongate member to one of the closure panel and a body of a vehicle and a distal end for coupling the elongate member to the other of the closure panel and the body of the vehicle 200, and the further step 204 of controlling a motor to move at least one continuously variable force application member to vary a force applied on the elongate member in response to a signal supplied from an electronic controller.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power-operated variable force door check mechanism, comprising:
at least one continuously variable force application member configured to apply a force on an elongate member attached to a vehicle closure panel while the vehicle closure panel is being moved between opened and closed positions;
an adjuster configured in operable communication with said at least one continuously variable force application member; and
a motor configured in operable communication with said adjuster, said motor being selectively energizable to cause said adjuster to move and vary the force applied by said at least one continuously variable force application member on said elongate member.

2. The power-operated variable force door check mechanism of claim 1, wherein said at least one continuously variable force application member is a spring member that is axially compressible and axially expandable in response to movement of said adjuster to selectively vary the force applied by said at least one spring member on said elongate member while the vehicle closure panel is being moved between opened and closed positions.

3. The power-operated variable force door check mechanism of claim 2, wherein said adjuster is a linear actuator in including at least one screw and at least one nut configured for translation along said at least one screw.

4. The power-operated variable force door check mechanism of claim 2, wherein said at least one continuously variable force application member includes a plurality of spring members.

5. The power-operated variable force door check mechanism of claim 4, wherein said plurality of spring members includes a pair of spring members coaxially aligned with one another across opposite surfaces of said elongate member.

6. The power-operated variable force door check mechanism of claim 5, further including a pair of engagement members, a separate one of said engagement members being disposed between a separate one of said spring members and a separate one of said opposite surfaces of said elongate member.

7. The power-operated variable force door check mechanism of claim 5, wherein said adjuster is a linear actuator including a pair of screws extending in parallel relation with one another on opposite sides of said elongate member and a plurality of drive nuts configured for translation along said screws.

8. The power-operated variable force door check mechanism of claim 7, wherein said plurality of drive nuts includes a pair of lower drive nuts interconnected with one another by a lower pusher member and a pair of upper drive nuts interconnected with one another by an upper pusher member, said lower pusher member engaging one of said pair of spring members and said upper pusher member engaging the other of said pair of spring members.

9. The power-operated variable force door check mechanism of claim 8, wherein each one of said pair of screws includes a right-hand helical thread region and a left-hand helical thread region, said pair of lower drive nuts being in threaded engagement with one of said right-hand helical thread regions and said left-hand helical thread regions and said pair of upper drive nuts being in threaded engagement with the other of said right-hand helical thread regions and said left-hand helical thread regions.

10. The power-operated variable force door check mechanism of claim 2, wherein said at least one screw translates to contract said at least one spring member to increase the force of said at least one spring member upon said at least one nut being rotated in a first direction and allows said at least one spring member to expand to decrease the force of said at least one spring member upon said at least one nut being rotated in a second direction opposite said first direction.

11. A power-operated variable force door check system, comprising:
at least one continuously variable force application member configured to apply a force on an elongate member configured to move a vehicle closure panel between open and closed positions;
an adjuster configured in operable communication with said at least one continuously variable force application member;
a motor configured in operable communication with said adjuster; and
an electronic control module configured in electrical communication with said motor, wherein said motor is energizable in response to a signal from said electronic control module to selectively adjust the force applied to said elongate member by said at least one continuously variable force application member.

12. The power-operated variable force door check system of claim 11, wherein said at least one continuously variable force application member is a spring member that is axially compressible and axially expandable in response to movement of said adjuster to selectively vary the force applied by said at least one spring member on said elongate member while the vehicle closure panel is being moved between opened and closed positions.

13. The power-operated variable force door check system of claim 12, wherein said adjuster is a linear actuator in including at least one screw and at least one nut configured for translation along said at least one screw.

14. The power-operated variable force door check system of claim 12, wherein said at least one continuously variable force application member includes a plurality of spring members.

15. The power-operated variable force door check system of claim 14, wherein said adjuster is a linear actuator in including a pair of screws extending in parallel relation with one another on opposite sides of said elongate member and a plurality of drive nuts configured for translation along said screws.

16. The power-operated variable force door check system of claim 15, wherein said plurality of drive nuts includes a pair of lower drive nuts interconnected with one another by a lower pusher member and a pair of upper drive nuts interconnected with one another by an upper pusher member, said lower pusher member engaging one of said plurality of spring members and said upper pusher member engaging another of said plurality of spring members.

17. A method of controlling movement of a closure panel of a vehicle, comprising:
providing an elongate member having a proximal end configured to be coupled to one of the closure panel and a body of the vehicle and a distal end configured to be coupled to the other of the closure panel and the body of the vehicle; and
controlling a motor to move at least one continuously variable force application member to vary a force applied on the elongate member in response to a signal supplied from an electronic controller.

18. The method of claim 17, wherein the step of controlling the motor includes increasing the force applied on the elongate member to one of preventing or reducing movement of the closure panel in response to the electronic controller detecting an acceleration of the vehicle closure panel above a predetermined threshold and decreasing the force applied on the elongate member to allow movement of the closure panel in response to the electronic controller detecting an acceleration of the vehicle closure panel below a predetermined threshold.

19. The method of claim 17, further including the step of determining the inclination of the vehicle closure panel and controlling the motor to vary the force applied on the elongate member in response to the determined inclination.

20. The method of claim 17, further comprising the step of determining the position of the vehicle closure panel corresponding to a nearly closed position and controlling the motor to increase the force applied on the elongate member in response to the determined position of the vehicle closure panel and urging the vehicle closure panel to a fully closed position.
